(19) United States
(12) Patent Application Publication
(10) Pub. No.: US 2021/0162659 A1
(43) Pub. Date: Jun. 3, 2021

(54) PACKING A THREE-DIMENSIONAL BUILD BED

(71) Applicant: Hewlett-Packard Development Company, L.P., Spring, TX (US)

(72) Inventors: David Woodlock, Vancouver, WA (US); David Tucker, Vancouver, WA (US); Jun Zeng, Palo Alto, CA (US)

(73) Assignee: Hewlett-Packard Development Company, L.P., Spring, TX (US)

(21) Appl. No.: 17/047,020

(22) PCT Filed: Aug. 17, 2018
(86) PCT No.: PCT/US2018/046895

§ 371 Date: Oct. 12, 2020

(51) Int. Cl. B29C 64/171; B29C 64/393; B29C 64/245; B33Y 50/02

(52) U.S. Cl. CPC B29C 64/171; B29C 64/393; B33Y 10/00; B33Y 50/02; B29C 64/245

(57) ABSTRACT

A method of packing a three-dimensional (3D) build bed includes, with a shape-based packing module, and for a number of iterations, selecting two parts from a plurality of parts within a parts list, and minimizing a volume of a composite bounding box that encloses both parts. The method may also include determining abounding box reduction ratio (BBRR) by computing the volume of the composite bounding box divided by a sum of the volumes of a first bounding box enclosing a first part of the two parts and a second bonding box enclosing a second part of the two parts, and, in response to a determination that the BBRR is lower than a threshold value, combining the two parts to form a composite part.

### BACKGROUND

Three-dimensional (3D) printing is dramatically changing the manufacturing landscape. Via 3D printing, articles and components may be manufactured without the resources of a factory or other large-scale production facility. Additive manufacturing systems produce three-dimensional (3D) objects by building up layers of material and combining those layers using adhesives, heat, chemical reactions, and other coupling processes. Some additive manufacturing systems may be referred to as “3D printing devices.” The additive manufacturing systems make it possible to convert a computer aided design (CAD) model or other digital representation of an object into a physical object. Digital data is processed into slices each defining that part of a layer or layers of build material to be formed into the object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a computing device for packing a three-dimensional (3D) build bed, according to an example of the principles described herein.

FIG. 2 is a block diagram of a computing device for packing a three-dimensional (3D) build bed, according to an example of the principles described herein.

FIG. 3 is a block diagram of a build bed of parts including composite bounding boxes for combinations of parts within a build bed, according to an example of the principles described herein.

FIG. 4 is a block diagram of a build bed of parts including a thermal margin between parts, according to an example of the principles described herein.

FIG. 5 is a flowchart showing a method of packing a three-dimensional (3D) build bed, according to an example of the principles described herein.

FIG. 6 is a flowchart showing a method of packing a three-dimensional (3D) build bed, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

As described herein, in some examples, a gas discharge illuminant such as a laser device may perform heating of materials very quickly and with high intensity. The speed with which such heating via the gas discharge illuminant occurs can substantially reduce the amount of time involved to additively manufacture a 3D object because it permits faster depositing of successive layers of material. Some additive manufacturing devices and systems use a build technique referred to as selective laser melting (SLM). SLM is an additive manufacturing technique that uses a material-forming laser as the power source to heat, melt, or sinter powdered material such as metals, ceramics, and other materials, aiming the laser automatically at points in space defined by a 3D model, melting the material together to create a solid structure. In some examples, SLM additive manufacturing processes melt a metal powder to a temperature above that metal powder's melting point in order to maintain presence of a melted pool of metal material continually along a print path and allowing the melted metal material to solidify after the melting. Overheating the molten metal pool and surrounding regions may increase the probability that defects are formed in the 3D object.

SLM is popular as a 3D metal additive manufacturing process and aims the material-forming laser automatically at points in space defined by a 3D model. The laser melts the material together to create a solid structure allowing at least one of a number of different properties of the material to be altered such as, for example, magnitudes or degrees of texture, porosity, rigidity, pliability, elasticity, strength, reflectivity, intensity, conductivity, and chromaticity, among other properties of the formed 3D object. Further, the alteration of the at least one property may include heating, drying, curing, melting, or fusing, as well as additional transformations, such as plasticization, or other chemical changes. The material melted may be any powdered material such as a plastic or metal, an agent-carrying ink, other materials and combinations thereof.

SLM additive manufacturing processes rely on heating a small area on the surface of a bed of metal powder with a focused laser beam capable of raising an irradiated powder's temperature above the metal melting point. The movement or scanning of the laser beam provides stitching of the heated, sintered, or molten metal pools to solidify into an extended solid metal shape.

Although additive manufacturing processes such as SLM additive manufacturing produce reliable parts at a fast rate, in some examples, these additive manufacturing processes may be hindered or slowed down by ineffectively packing the build bed of the 3D printing device. To drive up throughput of the acceptable parts for additive manufacturing process such as multi-jet fusion manufacturing processes developed by HP, Inc., parts packing within the build bed may be optimized. For example, a high packing density may be provided such that a maximum number of parts may be fabricated simultaneously in a single print job that utilizes the entirety of the build bed. This increases the throughput of the 3D printing device, or the ability of the 3D printing device to print more parts in a single print job.

Further, appropriately packing the build bed of the 3D printing device includes consideration of thermal increases, decreases, and fluctuations each part goes through during the heat-intensive additive manufacturing process. Addressing any thermal issues including thermal cross-talk that may be present between two printed parts helps to decrease the possibility of producing a part with a manufacturing defect. Thus, it is an objective to include as many parts in a build bed as possible without sacrificing the quality of the printed parts.

To effectively pack a build bed of the 3D printing device, the computational costs for industrial scale applications may be taken into consideration. If the computational costs are too high, it may not be beneficial to spend an excessive amount of computational time to more effectively pack a build bed. Some build bed packing processes are optimized based on the geometry of a part including more than a few vertices used in describing a single object in the packing process. Further, industrial applications may potentially involve hundreds of objects to be processed for packing.

Packing the build bed of the 3D printing device includes combinatory optimization issues where computational costs increase exponentially with the increase in the number of parts involved in the packing process. In other words, packing the build bed may follow a computational complexity theory referred to as a nondeterministic polynomial time-complete (NP-complete) decision process. Although any given solution to an NP-complete problem may be verified quickly in polynomial time, there is no known efficient way to locate a solution; the most notable characteristic of NP-complete problems is that no fast solution to them is known. That is, the time required to solve the problem using any process or algorithm increases very quickly as the size of the problem grows. Thus, in NP-complete, the computational cost grows exponentially with number of objects involved.

Thus, part packing of a building bed is a combinatory optimization technique within a 3D computational geometry environment, and is an NP-complete intensive task where the computational cost grows exponentially with the number of parts involved in the packing process. Industrial applications may potentially involve several hundred parts to be packed within the build bed, and it takes considerable computational time to achieve optimal packing density. The examples described herein address part packing by pre-grouping the parts into composite parts and arranging the composite parts within the build bed. This reduces the effective part count for the packing process and accelerates the computing significantly.

Further, the ability to produce a part with the desired functional quality may be increased if each voxel that forms the part goes through a similar thermal experience in order to minimize any functional irregularities such as built-in thermal stress which may result in warpage of portions of the parts. The examples described herein address the thermal environments that parts are subjected to during the 3D printing process by, in part, preserving the thermal environment of a given part by combining and orienting similar or identical parts in a similar or identical location and/or orientation within the build bed.

Examples described herein provide a method for packing a three-dimensional (3D) build bed. The method includes, with a shape-based packing module, and for a number of iterations, selecting two parts from a plurality of parts within a parts list, and minimizing a volume of a composite bounding box that encloses both parts. The method may also include determining a bounding box reduction ratio (BBRR) by computing the volume of the composite bounding box divided by a sum of the volumes of a first bounding box enclosing a first part of the two parts and a second bonding box enclosing a second part of the two parts, and, in response to a determination that the BBRR is lower than a threshold value, combining the two parts to form a composite part.

The method may include, in response to a determination that the BBRR is lower than a threshold value, removing the first part and the second part from the parts list, and adding the composite part to the parts list. The method may also include, in response to a determination that the number of parts within the composite part exceeds a composite threshold, adding the composite part to a composite parts list for printing. In response to a determination that the BBRR is higher than a threshold value, the method includes not combining the two parts and returning the two parts to the parts list.

The method may also include determining a thermal margin of each part defining a minimum part placing distance that minimizes thermal cross-talk with a neighboring part, and storing data defining the thermal margin for each part. Minimizing the volume of the composite bounding box that encloses both parts may be based on the thermal margin. Performing the method for the number of iterations includes performing the method the number of iterations until the parts list is empty, or performing the method the number of iterations until a threshold time limit has been reached. Further, the method may include packing the composite parts into the build bed based on an optimal position and orientation, and printing the parts packed into the build bed.

Examples described herein provide a computer program product for packing a three-dimensional (3D) build bed. The computer program product includes a computer readable storage medium including computer usable program code embodied therewith. The computer usable program code, when executed by a processor, and for a number of iterations, selects two parts from a plurality of parts within a parts list, minimizes a volume of a composite bounding box that encloses both parts, and determines a bounding box reduction ratio (BBRR) for the composite bounding box.

In response to a determination that the BBRR is lower than a threshold value, the method may include combining the two parts to form a composite part, removing the first part and the second part from the parts list, and adding the composite part to the parts list. In response to a determination that the number of parts within the composite part exceeds a composite threshold, the method may include adding the composite part to a composite parts list for printing, and, in response to a determination that the BBRR is higher than a threshold value, not combining the two parts and returning the two parts to the parts list. Determining the BBRR for the composite bounding box may include computing the volume of the composite bounding box divided by a sum of the volumes of a first bounding box enclosing a first part of the two parts and a second bonding box enclosing a second part of the two parts.

The computer usable program code, when executed by the processor, may determine a thermal margin of each part defining a minimum part placing distance that minimizes thermal cross-talk with a neighboring part, and store data defining the thermal margin for each part. Minimizing the volume of the composite bounding box that encloses both parts is based on the thermal margin. The number of iterations may include the number of iterations until the parts list is empty or the number of iterations until a threshold time limit has been reached. The computer usable program code may, when executed by the processor measure the BBRR for every part within the parts list matched with every other part, and determine a combination of matches that create an optimized outcome.

Examples described herein provide a computing device for packing a three-dimensional (3D) build bed. The computing device includes a processor, and a data storage device communicatively coupled to the processor. The computing device also includes a shape-based packing module, stored in the data storage device and executable by the processor to, when executed by the processor, and for a number of iterations, select two parts from a plurality of parts within a parts list, minimize a volume of a composite bounding box that encloses both parts, and determine a bounding box reduction ratio (BBRR) by computing the volume of the composite bounding box divided by a sum of the volumes of a first bounding box enclosing a first part of the two parts and a second bonding box enclosing a second part of the two parts.

In response to a determination that the BBRR is lower than a threshold value, the computing device combines the two parts to form a composite part, removes the first part and the second part from the parts list, and adds the composite part to the parts list. The shape-based packing module, when executed by the processor, and in response to a determination that the BBRR is higher than a threshold value, does not combine the two parts and returns the two parts to the parts list. In response to a determination that the number of parts within the composite part exceeds a composite threshold, the computing device adds the composite part to a composite parts list for printing.

The shape-based packing module, when executed by the processor, determines a thermal margin of each part defining a minimum part placing distance that minimizes thermal cross-talk with a neighboring part, and stores data defining the thermal margin for each part. Minimizing the volume of the composite bounding box that encloses both parts may be based on the thermal margin.

As used in the present specification and in the appended claims, the term “parts list” is meant to be understood broadly as any collection of parts from which may be selected at least one part for printing by a 3D printing device. In an example, a user or other individual may add any part to the part list in anticipation for printing of the part. The parts within the parts list may be selected for arrangement in a print bed in order to print the parts in a cost effective manner.

As used in the present specification and in the appended claims, the term “bounding box” is meant to be understood broadly as a boundary around a part or a composite part that defines a minimum part placing distance that minimizes the possibility of neighboring parts within a print bed from bonding to one another during a 3D printing process. In one example, a bounding box may also define a minimum part placing distance that minimizes thermal cross-talk with a neighboring part.

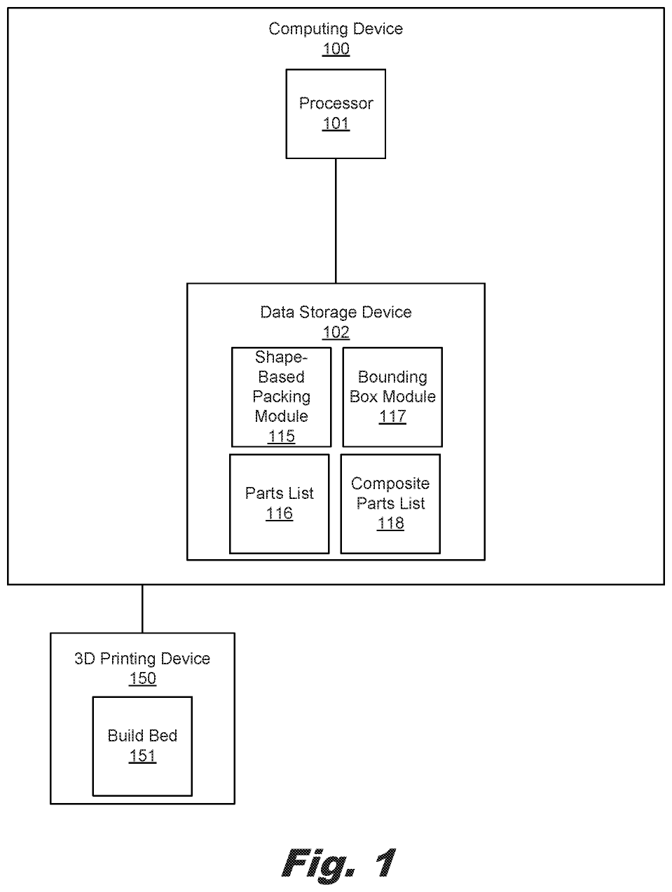

Turning now to the figures, FIG. 1 is a block diagram of a computing device (100) for packing a three-dimensional (3D) build bed (151) of a 3D printing device (150), according to an example of the principles described herein. The computing device (100) may include a processor (101), and a data storage device (102) communicatively coupled to the processor (101). The data storage device (102) may store a shape-based packing module (115) that is executable by the processor (101). When executed by the processor (101), the shape-based packing module (115), for a number of iterations, selects two parts from a plurality of parts within a parts list (116). The parts are defined by data, and may be stored in a 3D printing format readable and printable by the 3D printing device (150). In one example, the shape-based packing module (115) may be VOXELPACK® shape-based packing module developed and distributed by HP, Inc.

The shape-based packing module (115) also minimizes a volume of a composite bounding box that encloses both parts that were selected from the parts list (116). A bounding box module (117) may also be stored in the state storage device (102) and is executable by the processor (101). The bounding box module (117), when executed by the processor (101), determines a bounding box reduction ratio (BBRR) for the two parts. The BBRR is determined by computing the volume of the composite bounding box that encloses the two parts, and divides this volume by a sum of the volumes of a first bounding box that encloses a first part of the two parts and a second bonding box that encloses a second bounding box of a second part of the two parts. A threshold BBRR is then determined through user-input or automatically by the shape-based packing module (115).

In one example, the BBRR may be measured for every part matched with every other part to find the combination of matches that create an optimized outcome. This is an entirely exhaustive matching processes and is extremely computationally intensive. For this reason, the number of matches between all the parts in the parts list (116) may be regulated to ensure that the process completes in a timely manner while still allowing for the benefit of attempting as many combinations of parts as possible.

In response to a determination that the BBRR is lower than the threshold value, the two parts are combined to form a composite part, and the first part and the second part are removed from the parts list (116). The new composite part including the first and second parts is added back to the parts list (116). The new composite part may function as a part in the parts list (116) where the composite part may be added to another part in the parts list (116) to form another composite part that includes the first and second parts and the new third part.

This process is performed any number of iterations until all the parts in the part list are combined with at least one other part and the parts list is empty, until the composite parts cannot be added to because their combination will no longer fit within the dimensions of the build bed (151), or until a threshold time limit has been reached. As the parts are removed from the parts list and combined to a point to where they no longer fit within the dimensions of the build bed (151), they may be added to the composite parts list (118) where they await to be packed into the build bed (151) based on an optimal position and orientation within the build bed (151). In one example, a user may override decisions the computing device (100) makes as to the composition of a composite part by rejecting the composite part, selecting two or more parts that are to form a composite part, or combinations thereof.

The threshold time limit may be set by a user or automatically selected by the computing device (100). In an example, the computing device (100) may determine that the time taken to combine parts may be too computationally burdensome and that combination of parts may suffer from the drawbacks of NP-complete where the computational cost to process more combination possibilities grows exponentially as the number of parts in the parts list (116) grows. Thus, the computing device (100) may restrict the time allotted for exploring possible combinations of parts. In one example, the user may tune the amount of time the computing device (100) may take in forming composite parts. In this example, the computing device (100) may prompt the user for directions as to how long the computing device (100) may take in computing best composite parts.

Thus, the computing device (100) selects parts from the parts list (116) to form a plurality of groups of parts referred to herein as composite parts. For each composite part, a preliminary packing processes is carried out to form an output packing solution that is a single composite part. Final packing of the build bed (151) of the 3D printing device (150) may be carried out with the resulting set of composite parts. In this manner, the computational cost may be significantly reduced since the computational cost is function of a total count of the composite parts. Further, since the parts within a composite object are stationery such that their relative distances and orientations are fixed, the thermal environment that the parts may be subjected to during the 3D printing process are constant relative to neighboring parts. This improves consistency of the thermal parameters of the parts during printing.

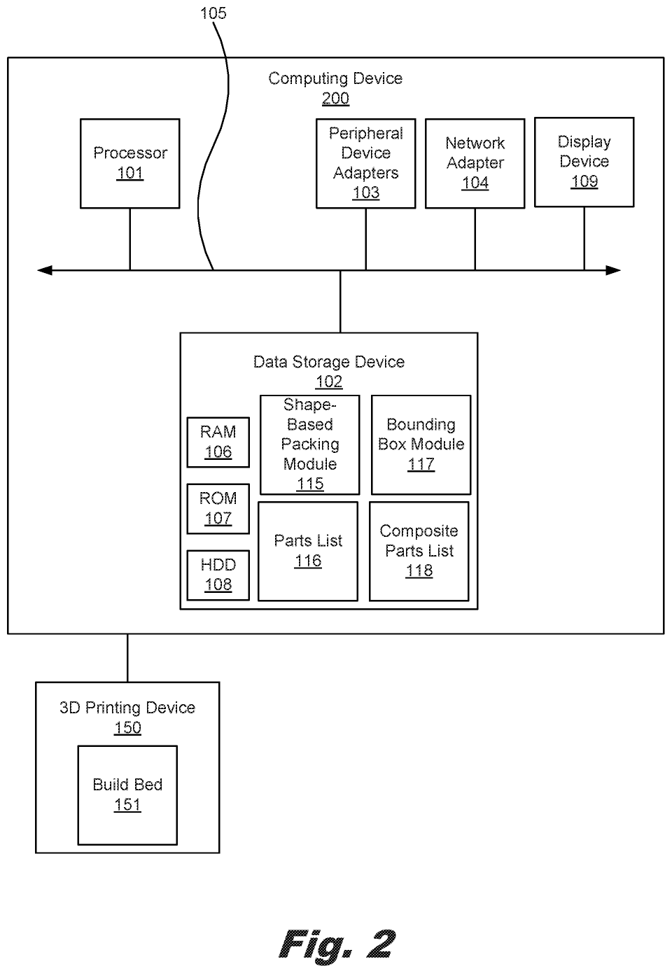

FIG. 2 is a block diagram of a computing device (200) for packing a three-dimensional (3D) build bed (151), according to an example of the principles described herein. Several elements present in FIG. 2 are also present in FIG. 1, and their description is provided in connection with FIG. 1. The computing device (200) may be implemented in an electronic device. Examples of electronic devices include servers, desktop computers, laptop computers, personal digital assistants (PDAs), mobile devices, smartphones, gaming systems, and tablets, among other electronic devices. The computing device (200) is coupled to a 3D printing device (150). In one example, the computing device (200) and 3D printing device (150) or elements of each may be integrated together as a single electronic device.

The computing device (200) may be utilized in any data processing scenario including, stand-alone hardware, mobile applications, through a computing network, or combinations thereof. Further, the computing device (200) may be used in a computing network, a public cloud network, a private cloud network, a hybrid cloud network, other forms of networks, or combinations thereof. In one example, the methods provided by the computing device (200) are provided as a service over a network by, for example, a third party. In this example, the service may include, for example, the following: a Software as a Service (SaaS) hosting a number of applications; a Platform as a Service (PaaS) hosting a computing platform including, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the computing device (200) are executed by a local administrator.

To achieve its desired functionality, the computing device (200) includes various hardware components. Among these hardware components may be a number of processors (101), a number of data storage devices (102), a number of peripheral device adapters (103), and a number of network adapters (104). These hardware components may be interconnected through the use of a number of busses and/or network connections such as, for example, bus (105).

The processor (101) may include the hardware architecture to retrieve executable code from the data storage device (102) and execute the executable code. The executable code may, when executed by the processor (101), may cause the processor (101) to implement at least the functionality of selecting parts from a plurality of parts within a parts list, minimizing a volume of a composite bounding box that encloses the selected parts, determining a bounding box reduction ratio (BBRR), combining the parts to form a composite part based on the BBRR, removing parts from parts lists, adding composite parts to the parts list, adding composite parts to a composite parts list, determining a thermal margin of each part, storing data defining the thermal margin for each part, packing composite parts into the build bed (151) of the 3D printing device (150) based on an optimal position and orientation, printing the parts packed into the build bed (151), and other processes according to the methods of the present specification described herein. In the course of executing code, the processor (101) may receive input from and provide output to a number of the remaining hardware units.

The data storage device (102) may store data such as executable program code that is executed by the processor (101) or other processing device. As will be discussed, the data storage device (102) may specifically store computer code representing a number of applications that the processor (101) executes to implement at least the functionality described herein. The data storage device (102) may include various types of memory modules, including volatile and nonvolatile memory. For example, the data storage device (102) of the present example includes Random Access Memory (RAM) (106), Read Only Memory (ROM) (107), and Hard Disk Drive (HDD) memory (108). Many other types of memory may also be utilized, and the present specification contemplates the use of many varying type(s) of memory in the data storage device (102) as may suit a particular application of the principles described herein. In certain examples, different types of memory in the data storage device (102) may be used for different data storage needs. For example, in certain examples the processor (101) may boot from Read Only Memory (ROM) (107), maintain nonvolatile storage in the Hard Disk Drive (HDD) memory (108), and execute program code stored in Random Access Memory (RAM) (106).

The data storage device (102) may include a computer readable medium, a computer readable storage medium, or a non-transitory computer readable medium, among others. For example, the data storage device (102) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The hardware adapters (103, 104) in the computing device (200) enable the processor (101) to interface with various other hardware elements, external and internal to the computing device (200). For example, the peripheral device adapters (103) may provide an interface to input/output devices, such as, for example, the 3D printing device (150), a display device (109), a mouse, or a keyboard, among other peripheral devices. The peripheral device adapters (103) may also provide access to other external devices such as an external storage device, a number of network devices such as, for example, servers, switches, and routers, client devices, other types of computing devices, and combinations thereof.

The display device (109) may be provided to allow a user of the computing device (200) to interact with and implement the functionality of the computing device (200) and the 3D printing device (150). The peripheral device adapters (103) may also create an interface between the processor (101) and the display device (109), a printer, or other media output devices. The network adapter (104) may provide an interface to other computing devices within, for example, a network, thereby enabling the transmission of data between the computing device (200) and other devices located within the network including the 3D printing device (150).

The display device (109) of the computing device (200) may, when executed by the processor (101), display the number of graphical user interfaces (GUIs) associated with the executable program code representing the number of applications stored on the data storage device (102). The GUIs may include aspects of the executable code including the display to the user of the parts being combined into a composite part, the manner in which the composite parts are packed into the build bed (151), and other graphical representations of the methods described herein. Examples of display devices (109) include a computer screen, a laptop screen, a mobile device screen, a personal digital assistant (PDA) screen, and a tablet screen, among other display devices (106).

The computing device (200) further includes a number of modules used in the implementation of the processes and methods described herein. The various modules within the computing device (200) include executable program code that may be executed separately. In this example, the various modules may be stored as separate computer program products. In another example, the various modules within the computing device (200) may be combined within a number of computer program products; each computer program product including a number of the modules. The computing device (200) may include the shaped-based packing module (115) and bounding box module (117) described herein in connection with FIG. 1.

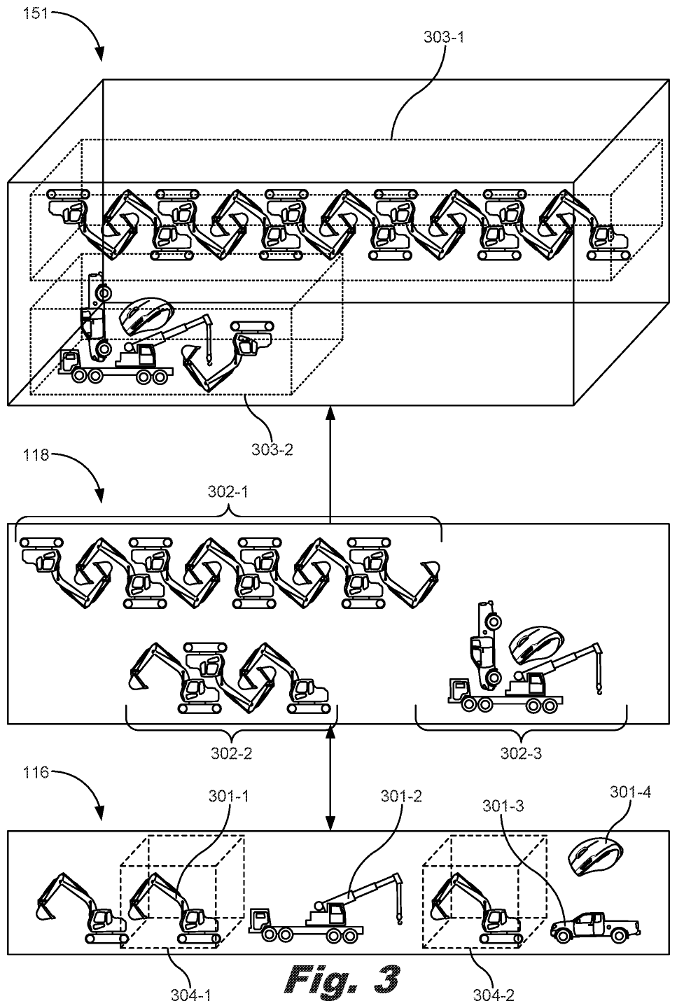

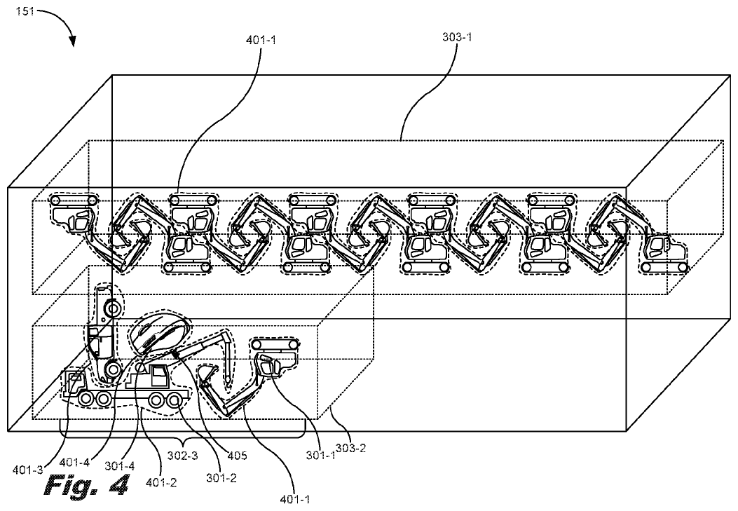

The manner in which the shaped-based packing module (115) and bounding box module (117) will now be described in connection with FIGS. 3 and 4. FIG. 3 is a block diagram of a build bed (151) of parts (301-1, 301-2, 301-3, 301-4, collectively referred to herein as 301) including composite bounding boxes (303-1, 303-2, collectively referred to herein as 303) for combinations of parts (301) within a build bed (151), according to an example of the principles described herein. FIG. 4 is a block diagram of a build bed (151) of parts (301) including a thermal margin (401-1, 401-2, 401-3, 401-4, collectively referred to herein as 401) between parts (301), according to an example of the principles described herein.

The parts (301) included in the parts list (116) may include any type of part that may have functional or aesthetic properties. For simplicity, the parts (301) depicted in the figures are simple figurines including an excavator (301-1), a crane (301-2), a truck (301-3), and a computer mouse (301-4). The parts (301) may be selected by the shape-based packing module (115) for combination into composite parts (302-1, 302-2, 303-3, collectively referred to herein as 302). The composite parts (302) may either be moved back into the parts list (116) to allow for more parts (301) to be added to those composite parts (302) until the composite part (302) bounding box (303) that encloses the two or more parts (301) within the composite part (302). The bounding box module (117), when executed by the processor (101), determines the bounding box reduction ratio (BBRR) for the combination of parts (301) that make up the composite part (302). As the parts (301) are combined into the composite parts (302), the composite parts (302) may move between the parts list (116) and the composite parts list (118) to add parts (301) to the composite parts (302) until the parts list (116) is empty of all the parts (301) or composite parts (302), until a threshold time limit has been reached, until the number of parts (301) within a composite part (302) exceeds a threshold number of parts allowed within the composite part (302), until the dimensions of the bounding box (303) exceeds the size of the build bed (151) as in the case of bounding box (303-1), or combinations thereof.

As to the threshold number of parts (301) allowed within a composite part (302), the maximum allowed part (301) count fora given composite part (302) may be a tuning parameter between the optimal packing density and computing speed, and may be user-defined or tuned using a GUI presented on the display device (109). If a composite part (302) is allowed to have many individual parts (301), the computing speed may be much faster, but the packing density of the parts (301) is likely to be less optimal. This may be especially true if the parts (301) are not similar or the parts (301) in the parts list (116) are more diverse and do not include identical parts (301). In the case of FIG. 3, the existence of many excavators (301-1) in the parts list (116) has resulted in a full row of excavators (301-1) collected into a composite part (302) that fits in a bunding box (303-1) that spans the entire length of the build box (151). In other situations such as the composite part (302) within bounding box (303-2) has a much larger diversity of parts (301), and may not be the best manner of composite part (302) formation. In this case, the computing device (200) may take more time to better collect the parts (301) into a composite part (302) with a higher density.

With reference to FIG. 4, a thermal margin (401) may be defined around each of the composite parts (302). These thermal margins (401) are unique for each individual part (401) as indicated by designations 401-1, 401-2, 401-3, and 401-4. This thermal margin (401) may assist in determining the manner in which parts (301) are collected together to form the composite parts (302). For example, the shape-based packing module (115) and bounding box module (117) may consider the thermal margins (401) when forming the composite parts (302). The thermal margins (401) are the iso-thermal paddings of a part (301) defining a minimum part placing distance that minimizes thermal cross-talk with neighboring parts. To allow too much thermal cross-talk between formed parts within the build bed (151) during printing may result in parts with thermal defects. Thus, the shape-based packing module (115) and bounding box module (117) may determine the thermal margins (401) of each part (301), and the parts (301) may be combined into the composite parts (302) based at least in part on the thermal margins (401). In one example, the shape-based packing module (115) and bounding box module (117) may determine the thermal margins (401) for each of the parts (301), and replace data defining the parts (301) in the parts list (116) to include the definitions of the parts (301) along with their thermal margins (401).

In the example of FIG. 4, the thermal margin (401-4) of the computer mouse (301-4) overlaps the thermal margin (401-2) of the crane (301-2) at point 405. Because this overlap of determined thermal margins (401-2, 401-4) may lead to built-in thermal stresses in either or both of the computer mouse (301-4) and crane (301-2). In this situation, the shape-based packing module (115) and bounding box module (117) preclude the computer mouse (301-4) and crane (301-2) from being arranged this close to one another or in this arrangement, and may move at least the computer mouse (301-4) and crane (301-2) back to the parts list (116) for consideration in a subsequent combination into a different composite part (302).

Once the parts (301) are arranged into the composite parts (302) through execution of the shape-based packing module (115) and bounding box module (117), the composite parts (302) may be packed into the build bed (151) with an optimal position and orientation. Once the composite parts (302) have been packed into the build bed (151), the computing device (200) may send the data defining all the parts (301), their thermal margins (401), the composite parts (302), the arrangement of the composite parts (302) as packed in the build box (151), and print data defining the build of the parts (301) may be sent to the 3D printing device (150). The 3D printing device (150) may print the parts based on the data it received from the computing device (200).

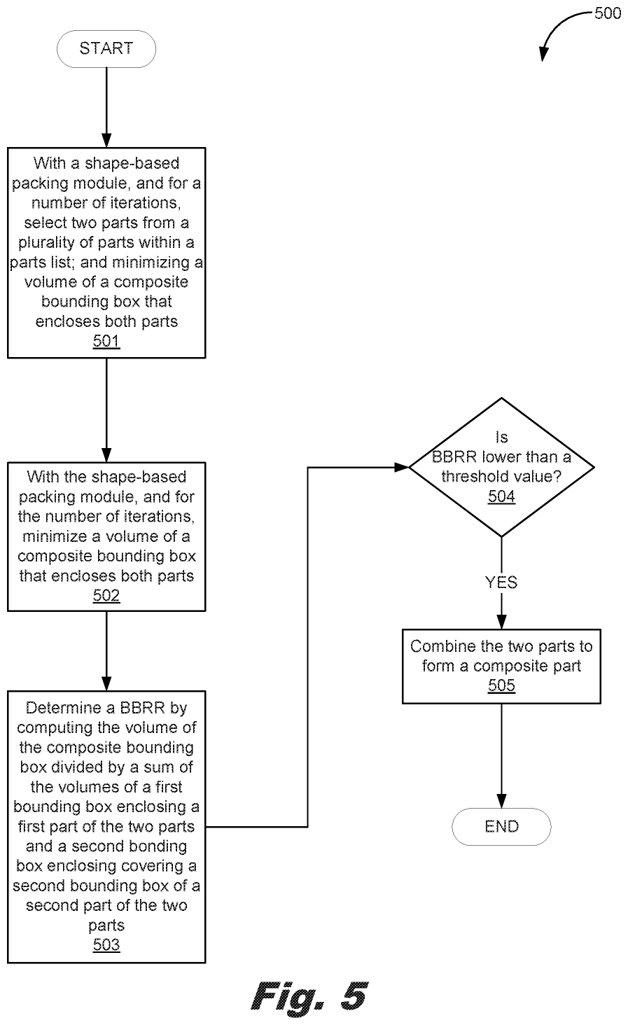

FIG. 5 is a flowchart showing a method (500) of packing a three-dimensional (3D) build bed (151), according to an example of the principles described herein. The method may include, with the shape-based packing module (115), and for a number of iterations, selecting (block 501) two parts (301) from a plurality of parts (301) within a parts list (116). The bounding box module (117) may be executed by the processor (101) along with the shape-based packing module (115) to minimize (block 502) a volume of a composite bounding box (303) that encloses both parts (301).

The method may also include determining (block 503) a bounding box reduction ratio (BBRR) by computing the volume of the composite bounding box (303) divided by a sum of the volumes of a first bounding box (304-1) that may enclose a first part (301) of the two parts and a second bonding box (304-2) that may enclose a second part (301) of the two parts as indicated in FIG. 3. In response to a determination that the BBRR is lower than a threshold value, the method (500) may include combining (block 505) the two parts (301) to form a composite part (302). The method (500) may also include removing the first part (301) and the second part (301) from the parts list (116), and the resulting composite part (302) may be added to the parts list (116).

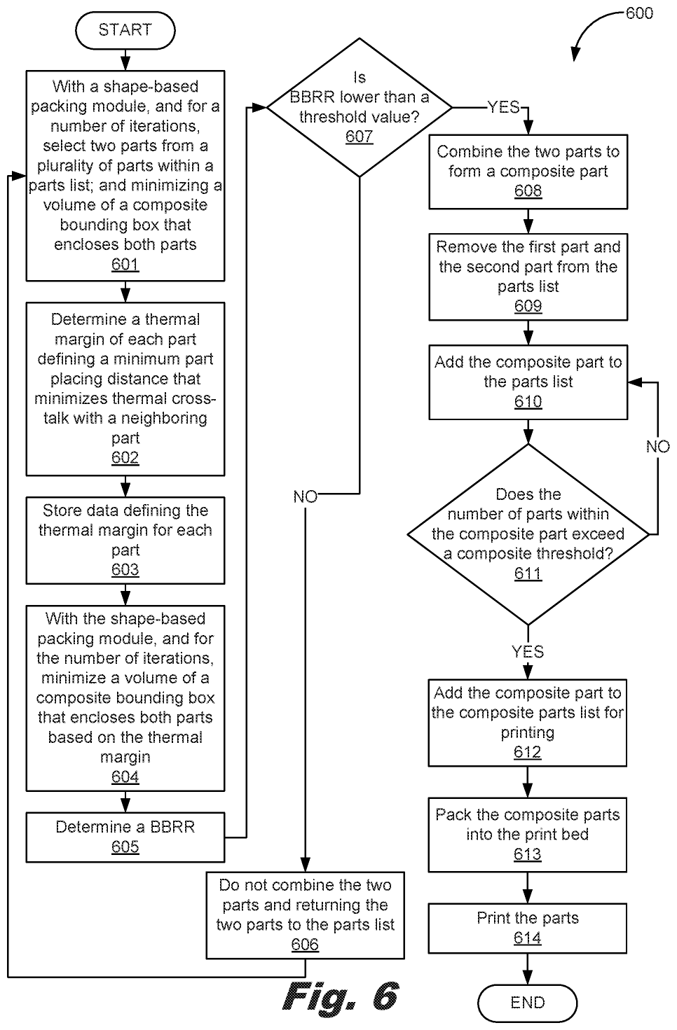

FIG. 6 is a flowchart showing a method (600) of packing a three-dimensional (3D) build bed (151), according to an example of the principles described herein. The method (600) may include, with the shape-based packing module (115), and for a number of iterations, selecting (block 601) two parts (301) from a plurality of parts (301) within a parts list (116), and minimizing a volume of a composite bounding box (303) that encloses both parts (301).

A thermal margin (401) of each part (301) defining a minimum part placing distance that minimizes thermal cross-talk with a neighboring part (301) maybe determined (block 602), and the data defining the thermal margin (401) for each part (301) may be stored (block 603) in the data storage device (102). In one example, the data defining the thermal margin (401) for each part (301) may be stored as additional data defining the parts (103) or may replace the data defining the parts (301) and to include both the data defining the parts (301) and their respective thermal margins (401).

The method (600) may also include, with the shape-based packing module (115), and for the number of iterations, minimizing (block 604) a volume of a composite bounding box (303) that encloses both parts based on the thermal margin (401). The thermal margin (401) defines how close the parts (301) within the composite part (302) may be to one another without the possibility of creating thermal defects as the parts (301) are printed.

The method may also include determining (block 605) a bounding box reduction ratio (BBRR) by computing the volume of the composite bounding box (303) divided by a sum of the volumes of a first bounding box (304-1) that may enclose a first part (301) of the two parts and a second bonding box (304-2) that may enclose a second part (301) of the two parts as indicated in FIG. 3. The method may then determine (block 607) if the BBRR is lower that a threshold value (607). In response to a determination that the BBRR is not lower than the threshold value (block 607, determination NO), then, at block 606, the two or more parts (301) are not combined and the parts are returned to the parts list (116) for combination with other parts (301) or to be combined in a different manner. The method (600) may then loop back to block 601 where the parts (301) may be addressed as described in connection with 601 through 607.

In response to a determination that the BBRR is lower than the threshold value (block 607, determination YES), then the method may proceed to block 608 where the two or more parts (301) are combined to form a composite part (302). The first part (301) and second part (302) are removed (block 609) from the parts list (116), and the composite part (302) is added to the parts list (116).

The method (600) may also include determining (block 611) whether the number of parts within the composite part exceed a composite threshold. The composite threshold may include adding parts (301) to the composite part (302) until the parts list (116) is empty of all the parts (301) or composite parts (302), until a threshold time limit has been reached, until the number of parts (301) within a composite part (302) exceeds a threshold number of parts allowed within the composite part (302), until the dimensions of the bounding box (303) exceeds the size of the build bed (151) as in the case of bounding box (303-1), or combinations thereof.

If the number of parts (301) within the composite part (302) do not exceed the composite threshold (block 611, determination NO), the method (600) may loop back to block 610 to allow for more parts (301) to be added to the composite part (302). If the number of parts (301) within the composite part (302) do exceed the composite threshold (block 611, determination YES), the composite part (302) may be added (block 612) to the composite part list (118) in preparation for printing. The print bed (151) is packed (block 613) with the composite parts (302) based on an optimal position and orientation within the build bed (151), and the parts (301) are printed (block 614).

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (101) of the computing device (200) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe methods and systems for packing a three-dimensional (3D) build bed. The method includes, with a shape-based packing module, and for a number of iterations, selecting two parts from a plurality of parts within a parts list, and minimizing a volume of a composite bounding box that encloses both parts. The method may also include determining a bounding box reduction ratio (BBRR) by computing the volume of the composite bounding box divided by a sum of the volumes of a first bounding box enclosing a first part of the two parts and a second bonding box enclosing a second part of the two parts, and, in response to a determination that the BBRR is lower than a threshold value, combining the two parts to form a composite part.

The systems and methods described herein provide for a faster, accelerated auto-packing of parts in a build bed to achieve high packing density, with an Improved yield. Through the use of the examples described herein, a given part will always have the same neighboring parts of the same location and/or orientation where the thermal environment for this part is preserved across different builds. Such preservation of a part's thermal environment improves consistency of the thermal aspects this part experiences during printing.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of packing a three-dimensional (3D) build bed, comprising:
with a shape-based packing module, and for a number of iterations:
selecting two parts from a plurality of parts within a parts list; and
minimizing a volume of a composite bounding box that encloses both parts;
determining a bounding box reduction ratio (BBRR) by computing the volume of the composite bounding box divided by a sum of the volumes of a first bounding box enclosing a first part of the two parts and a second bonding box enclosing a second part of the two parts; and
in response to a determination that the BBRR is lower than a threshold value, combining the two parts to form a composite part.

2. The method of claim 1, comprising, in response to a determination that the BBRR is lower than a threshold value:
remove the first part and the second part from the parts list; and
add the composite part to the parts list.

3. The method of claim 1, comprising, in response to a determination that the number of parts within the composite part exceeds a composite threshold, add the composite part to a composite parts list for printing.

4. The method of claim 1, comprising, in response to a determination that the BBRR is higher than a threshold value, not combining the two parts and returning the two parts to the parts list.

5. The method of claim 1, comprising:
determining a thermal margin of each part defining a minimum part placing distance that minimizes thermal cross-talk with a neighboring part; and
storing data defining the thermal margin for each part;
wherein minimizing the volume of the composite bounding box that encloses both parts is based on the thermal margin.

6. The method of claim 1, wherein performing the method for the number of iterations comprises performing the method the number of iterations until the parts list is empty, or performing the method the number of iterations until a threshold time limit has been reached.

7. The method of claim 1, comprising:
packing the composite parts into the build bed based on an optimal position and orientation; and
printing the parts packed into the build bed.

8. A computer program product for packing a three-dimensional (3D) build bed, the computer program product comprising:
a computer readable storage medium comprising computer usable program code embodied therewith, the computer usable program code to, when executed by a processor, for a number of iterations:
select two parts from a plurality of parts within a parts list;
minimize a volume of a composite bounding box that encloses both parts;
determine a bounding box reduction ratio (BBRR) for the composite bounding box;
in response to a determination that the BBRR is lower than a threshold value:
combine the two parts to form a composite part;
remove the first part and the second part from the parts list; and
add the composite part to the parts list;
in response to a determination that the number of parts within the composite part exceeds a composite threshold, add the composite part to a composite parts list for printing; and
in response to a determination that the BBRR is higher than a threshold value, not combining the two parts and returning the two parts to the parts list.

9. The computer program product of claim 8, wherein determining the BBRR for the composite bounding box comprise computing the volume of the composite bounding box divided by a sum of the volumes of a first bounding box enclosing a first part of the two parts and a second bonding box enclosing a second part of the two parts.

10. The computer program product of claim 8, comprising computer usable program code to, when executed by the processor:
determine a thermal margin of each part defining a minimum part placing distance that minimizes thermal cross-talk with a neighboring part; and
store data defining the thermal margin for each part,
wherein minimizing the volume of the composite bounding box that encloses both parts is based on the thermal margin.

11. The computer program product of claim 8, wherein the number of iterations comprises the number of iterations until the parts list is empty or the number of iterations until a threshold time limit has been reached.

12. The computer program product of claim 8, comprising computer usable program code to, when executed by the processor:
measure the BBRR for every part within the parts list matched with every other part; and
determine a combination of matches that create an optimized outcome.

13. A computing device for packing a three-dimensional (3D) build bed, comprising:
a processor;
a data storage device communicatively coupled to the processor;
a shape-based packing module, stored in the data storage device and executable by the processor to, when executed by the processor:
for a number of iterations:
select two parts from a plurality of parts within a parts list;
minimize a volume of a composite bounding box that encloses both parts;
determine a bounding box reduction ratio (BBRR) by computing the volume of the composite bounding box divided by a sum of the volumes of a first bounding box enclosing a first part of the two parts and a second bonding box enclosing a second part of the two parts; and
in response to a determination that the BBRR is lower than a threshold value:
combine the two parts to form a composite part;
remove the first part and the second part from the parts list; and
add the composite part to the parts list.

14. The computing device of claim 13, wherein the shape-based packing module, when executed by the processor:
in response to a determination that the BBRR is higher than a threshold value, does not combine the two parts and returns the two parts to the parts list; and
in response to a determination that the number of parts within the composite part exceeds a composite threshold, adds the composite part to a composite parts list for printing.

15. The computing device of claim 13, wherein the shape-based packing module, when executed by the processor:
determines a thermal margin of each part defining a minimum part placing distance that minimizes thermal cross-talk with a neighboring part; and
stores data defining the thermal margin for each part;
wherein minimizing the volume of the composite bounding box that encloses both parts is based on the thermal margin.
